(19) United States
(12) Patent Application Publication
(10) Pub. No.: US 2019/0174874 A1
(43) Pub. Date: Jun. 13, 2019

(54) Method and Device for Automatic Fitting tools of Athletic Foot Wear

(71) Applicants: Albert Lee, Mission Viejo, CA (US); Hae Kyung Lee, Laguna Woods, CA (US); Josephine Lee, Laguna Woods, CA (US)

(72) Inventors: Albert Lee, Mission Viejo, CA (US); Hae Kyung Lee, Laguna Woods, CA (US); Josephine Lee, Laguna Woods, CA (US)

(21) Appl. No.: 14/981,541

(22) Filed: Dec. 28, 2015

Related U.S. Application Data
(60) Provisional application No. 62/097,069, filed on Dec. 27, 2014.

(51) Int. Cl. A43D 1/02; G01B 11/02; G06T 7/62; G06F 3/0482; A43B 3/00

(52) U.S. Cl. CPC A43D 1/025; G01B 11/02; G06T 2207/30196; G06F 3/0482; A43B 3/0036; G06T 7/62

(57) ABSTRACT

A system for automatic fitting of athletic footwear comprises a measuring device of foot data that scans a user's foot at least at two directions; a user interface that questions the user, and/or observes the user's foot; an analyzing device that analyzes the foot data measured by the measuring device; and a knowledgebase database that stores data for footwear determination provided by the analyzing device. The analyzing device comprises a case based reasoning system that goes through adaptation process in a similarity matrix of previous cases which are retrieved from the knowledgebase database, and an expert system that operates a function that determines a footwear based on the data provided by the measuring device and the user interface.

### REFERENCE TO RELATED APPLICATION

This application claims priority on Provisional Application No. 62/097,069 filed on 27 Dec. 2014, the disclosure of which is incorporated by reference.

### FIELD OF THE INVENTION

The present invention is related to designing custom-made-footwear.

### BACKGROUND OF THE INVENTION

Various footwear exist for satisfying needs of wearers, especially athletes and dancers, which must consider various factors relating to physical characteristics of feet, and main functions performed by wearers.

### BRIEF SUMMARY OF THE INVENTION

An objective of the invention is to provide system and method for analyzing factors for providing optimum design for footwear.

The present invention provides a system for automatic fitting of athletic footwear comprising a measuring device of foot data that scans a user's foot at least at two directions; a user interface that questions the user, and/or observes the user's foot; an analyzing device that analyzes the foot data measured by the measuring device; and a knowledgebase database that stores data for footwear determination provided by the analyzing device.

The analyzing device comprises a case based reasoning system that goes through adaptation process in a similarity matrix of previous cases which are retrieved from the knowledgebase database.

The analyzing device further comprises an expert system that operates a function that determines a footwear based on the data provided by the measuring device and the user interface.

The analyzing device determines footwear based on user's personal preference provided by the user interface.

The footwear determination data provided by the analyzing device is fed into the knowledgebase database.

The system further comprises an automatic pattern generation tool to produce a custom-made-footwear, which receives footwear determination data from the analyzing device.

The analyzing device selects size and shape of footwear from a linked online store based on the footwear determination.

The data measured by the measuring device comprises length, width, height, compressiveness, and flexibility of user's feet.

The present invention also provides a method for automatic fitting of athletic footwear comprises steps of: measuring foot data, in which a user's foot is scanned at least at two directions; user interfacing, in which questions are provided to the user, and/or the user's feet are observed; analyzing, in which the foot data measured by the measuring device are analyzed; and storing data, in which data for footwear determination provided by the analyzing device is stored in a knowledgebase database.

In the analyzing step, a case based reasoning process goes through adaptation process in a similarity matrix of previous cases which are retrieved from the knowledgebase database, and an expert system operates a function that determines a footwear based on the data provided by the measuring step and the user interfacing step.

A footwear is determined based on user's personal preference provided by the user interfacing step.

The footwear determination data provided by the analyzing device is fed into the knowledgebase database.

### BRIEF DESCRIPTION OF THE DRAWINGS

FIG. 1 is a flow diagram showing an algorithm for selecting footwear according to the present invention;

FIG. 2 is a block diagram showing a device for selecting footwear according to the present invention; and

FIG. 3 is a flow diagram showing a method for selecting footwear according to the present invention.

### DETAILED DESCRIPTION OF THE INVENTION

### 1. Basic Methodology

The 3D Scanner (which can be a simple smart phone to a sophisticated 3D scanner) and Artificial Intelligence (Case Based Reasoning and other Expert Systems) tool are used to measure the athlete's feet and find a custom fit for athletic foot wear (including but not exclusive to Ballet Pointe Shoes and running shoes). The scanned data of feet will be collected and fed into the Knowledge Base System (which include Case Based Reasoning tool and Expert Systems) and the case based reasoning engine will produce several candidates of athletic footwear for each individual that could maximize athletic performance and safety. These recommendations from AI tools can be fed into an automatic pattern generation tool to produce a custom-made-footwear (made to order).

Automatic (Pointe) Shoe Fitting Process using 3D Scanner and AI tools (CBR and Expert System). 3D scan of feet using a smart phone camera to fit shoes.

The athlete will scan each of their foot using a camera on the application when it is flat on the floor and scan a second time while it is pointed. These 360 scans of feet will provide (in mm):

1. Exact measurements of length (from the most protruding part of the heel to the tip of the longest toe), width (at the metatarsal, where the bunion would be) and height (thickness) of feet

2. Length of each toe (from the base of the toe to the tip)

3. Measures height of arch (floor to the arch)

4. Categorizes the type of feet (Greek, Egyptian and Peasant)

5. Measures how compressive the feet are

Measures the width at the metatarsal when the foot is flat on the floor

Measures the width at the metatarsal when the foot is pointed

Measures the difference between the two measurements

6. Measures flexibility of feet

Measures length of the feet when it is flat on the floor

Measures the distance between the toe and the heel when it is pointed

Measures the difference between the two measurements

7. These measurements will go directly into the athlete's profile kept in the company archive and will provide the athlete with 3 or 4 (pointe) shoes that will work with their feet in the order of Good, Better and Best.

8. Each of the (pointe) shoes provided will link to the company's online store with the correct size and shape already selected for them for an easy one-click check out.

### 2. Algorithm for Selecting Perfect Footwear

The Algorithm for selecting perfect footwear utilizes CBR (x1, x2, . . . , q1, q2 . . . ) and F(x1, x2, x3, . . . q1, q2, . . .), which are Case Based Reasoning System and Expert System engines, to determine a perfect footwear for an athlete from a set of attributes defining the shape of an athlete's foot where X1, x2, represent attributes, which are considered to be important factors in selecting the perfect footwear.

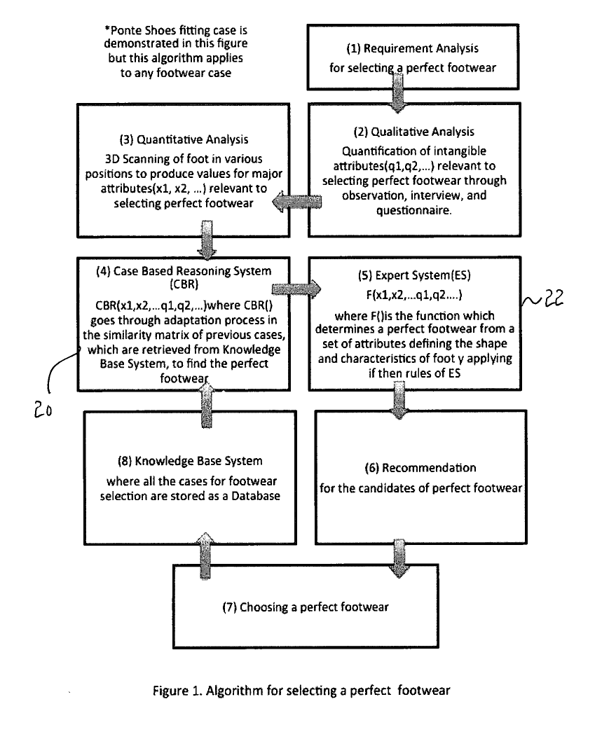

The algorithm for selecting perfect footwear is as shown in FIG. 1. As shown in FIG. 1, the algorithm starts with the requirement analysis about what are considered important factors or attributes to consider in selecting perfect footwear for each individual and goes through eight-step process in selecting perfect footwear. Among these attributes, there are some important considerations or attributes, which are not measurable or intangible. Examples of intangible attributes include ballet-related skill, experience, physical strength, body built, special shape of the foot, (relative toe lengths, thickness), user's preference for design and function of footwear etc. To obtain the values for these attributes, which are not measurable, we go through quantification process by observing and questioning in step 2. The results of quantification of intangible attributes, which are combined with the output of 3D scanning in step 3, are fed into Case Based Reasoning System and go through the adaptation process of similar cases, retrieved from the Knowledge base system, to find the candidates for a perfect fit footwear in step 4. The if-then rules in the Expert Systems (ES) in step 5, which are the domain expert knowledge or experience, are then applied to find best fit foot-wears from a set of candidates for best fit footwear in step 6. Each individual's personal preference then determines his or her perfect fit footwear in the step 7. The final outcome of this perfect fit footwear algorithm is fed into Knowledge Base System with updated information in step 8. This eight-step iterative process makes the Case Based Reasoning System better predictor as it accumulates more knowledge.

3. Definition of Major Attributes in Selecting Perfect Footwear Pointe shoes should fit like a glove. In order to find the perfect fit, there are three things to consider: the shape, the size, and the strength of the dancer's foot.

The Basic attributes used in the algorithm for AI footwear fitting are as follows

### X1. The Shape of the Foot

X11. The shape of the foot determines the type of the shoe. Foot shape can be divided into two groups: tapered foot and non-tapered foot. Egyptian foot (the first toe is the longest) and Greek foot (the second toe is the longest) are considered to be tapered foot and Peasant foot (the toes are even length) is non-tapered foot. It summarizes as below:
Greek narrow foot and Egyptian narrow foot need the tapered toe box.
Greek wide foot and Egyptian wide foot need the slightly tapered toe box.
Peasant foot needs the wide toe box.

X12. The length of the toe determines the vamp of the shoe. The vamp is the top of the box. The vamp is divided into 3 sizes: low vamp (V1) medium vamp (V2) and high vamp (V3). It summarizes as below:
Short toes need the low vamp (V1)
Medium toes need the medium vamp (V2)
Long toes need the high vamp (V3)

X13. The thickness of the foot determines the profile of the shoe. Profile is the height of the shoe. Profile of the shoe is divided into 3 sizes: low profile, medium profile, and high profile. It summarizes as below:
Shallow foot needs the low profile shoe
Average foot needs the medium profile shoe
Fuller foot needs the high profile shoe

### X2. The Size of the Foot

X21. Length of the foot

The length of the shoe should be larger than the foot length by a half-inch.

X22. The width of the shoe is decided by the width of the metatarsal of the foot and it is divided by 5 different width; 1X, 2X, 3X, 4X and 5X from the narrowest to the widest.

### Q1. Strength of the Foot

Q11. Strong feet need strong shanks. Shank consists of the outer and inner sole of the pointe shoe and it supports the dancer en pointe. The shank can be divided into 3 different hardness: soft, medium and hard. It summarizes as below:
Strong foot needs the strong shank.
Average foot needs the medium shank.
Weaker foot needs the soft shank.

Q12. The height of the arch is another aspect in determining the shank of the shoe.

Arch is the arched part of the bottom of the foot. The foot with a high arch generally need a harder shank than the low arch. It summarises as below:
High arched foot needs hard shank.
Medium arched foot needs medium shank.
Low arched foot needs soft shank.

Q13. The height of the arch is another aspect in determining the vamp of the shoe.

High arched foot needs high vamp to restrict the foot from popping out of the shoe.

It summarizes as below:
High arched foot needs high vamp (V3)
Medium arched foot needs medium vamp (V2)
Low arched foot needs low vamp (V1)

Q14. Experience En Pointe is also an important factor in deciding the shank. First pointe shoes shoe should start with the soft shank and stay on soft shank until the dancer gets stronger. But the choice of the shank should be flexible depending on their strength of the foot. It summarizes as below:
First pointe shoes to 6 months: Soft shank
6 months to 12 months: Soft to medium shank
12 months and up: medium to hard shank depending on their strength.

### 4. Basic Concepts of Section Process for Perfect Fit Footwear

The basic concepts associated with the attributes explained above are as follows:

### Basic Shapes

1) Greek Tapered
a. The length should be measured from the back of the heel all the way to the tip of the second toe (which is the longest) when standing on flat to give the second toe ample room to straighten
b. The athlete needs a sharply tapered box with a smaller platform to take the pressure off of the second toe and distribute the weight to the other toes
c. Example: Russian Pointe Entrada Pro

2) Greek Wide
a. The length should be measured from the back of the heel all the way to the tip of the second toe (which is the longest) when standing on flat to give the second toe ample room to straighten
b. The athlete needs a slightly tapered box to accommodate the width but still take the pressure off of the second toe and distribute the weight to the other toes so the second toe doesn't bare all the weight
c. The vamp and wings should be long enough to cover the toes and metatarsal area while short enough to roll through demi pointe without being restricted
d. Example: Bloch Heritage

3) Egyptian Tapered
a. The length should be measured from the back of the heel all the way to the tip of the big toe (which is the longest) when standing on flat
b. The athlete needs a sharply tapered box with a small platform to take the pressure off of the second toe and distribute the weight to the other toes
c. Example: Grishko 2007

4) Egyptian Wide
a. The length should be measured from the back of the heel all the way to the tip of the second toe (which is the longest) when standing on flat to give the second toe ample room to straighten
b. The athlete needs a sharply tapered box with a smaller platform to take the pressure off of the second toe and distribute the weight to the other toes
c. Example: Freed Classic

5) Peasant
a. The length should be measured from the back of the heel all the way to the tip of the toes when standing on flat
b. The athlete needs a wide platform to give enough room for all the toes. The pointe shoe shape should be more square to accommodate square feet shape
c. Example: Suffolk Stellar

*The more tapered the toes, the more tapered the shoes and the smaller the platform.

### Box Length

The length of the vamp and wings is determined by toe length and height of the arch. The vamp (top of the box) and the wings (sides of the box) should be long enough to cover the toes and metatarsal (where bunion should be) area while short enough to roll through demi pointe without being restricted. (For example athletes with short toes should opt for a shorter vamp, such as the Bloch Heritage while those with longer toes should consider a longer vamp such as the Grishko 2007). On the other hand, if the athlete has high arches and is “popping out” of the shoe, they should have a higher vamp to restrict the feet from coming out. In contrast, if the athlete has a lower arch, they should have a shorter vamp to help get over the platform.

### Shoe Height

The thickness of the foot (profile) determines the height of the crown. Generally, pointe shoe crowns are categorized as low, medium and high. If the feet are 1 inches or less, it is considered a low profile foot and needs a low crown (example: Russian Pointe Rubin). If the feet are about 1.5 inches in thickness, it is considered a medium profile and needs a medium crown (example: Freed classic). If it is 2 inches or more, it is considered a high profile foot and needs a high crown (example: Bloch Sonata). Best way to indicate if the height is a good fit, is if the shoe fits without any space between the shoe and the foot, and without the foot bulging over the box.

### Compressive

To measure how compressive a foot is, the device must measure how much the foot “shrinks” when pointed. Compressive feet have a tendency to fold and fall inside the pointe shoes, possibly jamming the toe at the bottom of the platform while standing on their toes. In order to prevent this, the device must measure the difference between the feet when it is flat on the floor and when it is pointed. The bigger the difference, the more compressive the feet are, and therefore should be fitted tighter. For compressive feet, the fit of the shoe should be closer to the size when it is pointed than when it is flat on the floor, and should consider a lower profile shoe.

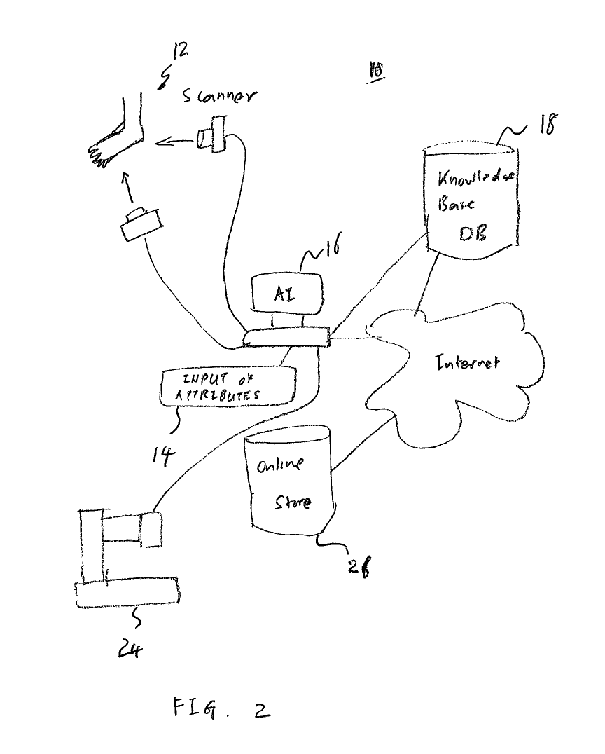

Referring to FIG. 2, a system 10 for automatic fitting of athletic footwear comprises a measuring device 12 of foot data that scans a user's foot at least at two directions; a user interface 14 that questions the user, and/or observes the user's foot; an analyzing device 16 that analyzes the foot data measured by the measuring device 12; and a Knowledgebase database 18 that stores data for footwear determination provided by the analyzing device 16.

Referring to FIG. 1, the analyzing device 16 comprises a case based reasoning system 20 that goes through adaptation process in a similarity matrix of previous cases which are retrieved from the knowledgebase database 18 and an expert system 22 that operates a function that determines a footwear based on the data provided by the measuring device 12 and the user interface 14.

The analyzing device 16 determines footwear based on user's personal preference provided by the user interface 14. The details of data obtained by the user interface are explained above in the qualitative analysis. The footwear determination data provided by the analyzing device 16 is fed into the knowledgebase database 18.

The system further comprises an automatic pattern generation tool 24 to produce a custom-made-footwear, which receives footwear determination data from the analyzing device 16.

The analyzing device 16 selects size and shape of footwear from a linked online store 26 based on the footwear determination.

The data measured by the measuring device 12 comprises length, width, height, compressiveness, and flexibility of user's feet, the details of which are explained above.

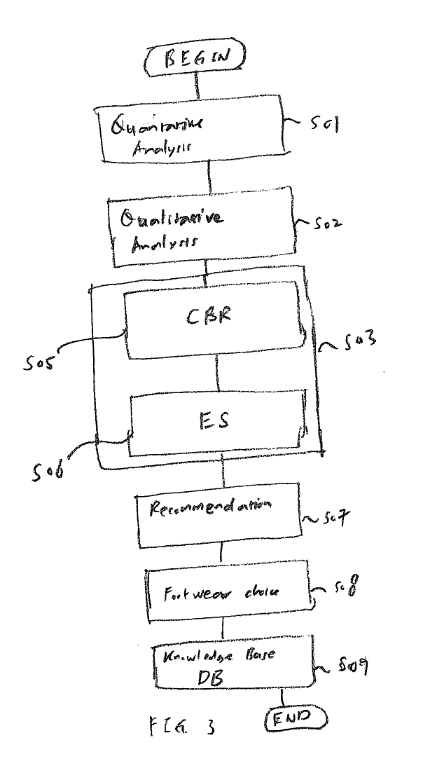

Referring to FIG. 3, a method for automatic fitting of athletic footwear comprises step S01 of measuring foot data, in which a user's foot is scanned at least at two directions; step S02 of user interfacing, in which questions are provided to the user, and/or the user's feet are observed; step S03 of analyzing, in which the foot data measured by the measuring device are analyzed; and step S04 of storing data, in which data for footwear determination provided by the analyzing step is stored in a knowledgebase database.

In the analyzing step S03, a case based reasoning process S05 goes through adaptation process in a similarity matrix of previous cases which are retrieved from the knowledgebase database, and an expert system process S06 operates a function that determines a footwear based on the data provided by the measuring step and the user interfacing step. Step S07 provides footwear determination as recommendation to the user. In Step S08, a footwear is chosen based on user's personal preference provided by the user interfacing step S02. In Step S09, the footwear determination data provided by the analyzing device is fed into the knowledgebase database.

1. A system for automatic fitting of athletic footwear comprising:
a) a measuring device of foot data that scans a user's foot at least at two directions;
b) a user interface that questions the user, and/or observes the user's foot;
c) an analyzing device that analyzes the foot data measured by the measuring device; and
d) a knowledgebase database that stores data for footwear determination provided by the analyzing device.

2. The system of claim 1, wherein the analyzing device comprises a case based reasoning system that goes through adaptation process in a similarity matrix of previous cases which are retrieved from the knowledgebase database.

3. The system of claim 2, wherein the analyzing device further comprises an expert system that operates a function that determines a footwear based on the data provided by the measuring device and the user interface.

4. The system of claim 3, wherein the analyzing device determines footwear based on user's personal preference provided by the user interface.

5. The system of claim 4, wherein footwear determination data provided by the analyzing device is fed into the knowledgebase database.

6. The system of claim 5, further comprising an automatic pattern generation tool to produce a custom-made-footwear, which receives footwear determination data from the analyzing device.

7. The system of claim 5, wherein the analyzing device selects size and shape of footware from a linked online store based on the footwear determination.

8. The system of claim 5, wherein the data measured by the measuring device comprises length, width, height, compressivenese, and flexibility of user's feet.

9. A method for automatic fitting of athletic footwear comprises steps of:
a) measuring foot data, in which a user's foot is scanned at least at two directions;
b) user interfacing, in which questions are provided to the user, and/or the user's feet are observed;
c) analyzing, in which the foot data measured by the measuring device are analyzed; and
d) storing data, in which data for footwear determination provided by the analyzing step is stored in a knowledgebase database.

10. The method of claim 9, wherein in the analyzing step, a case based reasoning process goes through adaptation process in a similarity matrix of previous cases which are retrieved from the knowledgebase database.

11. The method of claim 10, wherein an expert system operates a function that determines a footwear based on the data provided by the measuring step and the user interfacing step.

12. The method of claim 11, wherein a footwear is determined based on user's personal preference provided by the user interfacing step.

13. The method of claim 11, wherein footwear determination data provided by the analyzing device is fed into the knowledgebase database.

14. The method of claim 11, wherein the data measured In the measuring step comprises length, width, height, compressiveness, and flexibility of user's feet.
